(19) United States
(12) Patent Application Publication
(10) Pub. No.: US 2026/0346418 A1
(43) Pub. Date: Nov. 5, 2026

(54) INSERTION END OF A TOOL, RELATED MANUFACTURING METHOD AND TOOL HOLDER

(71) Applicant: Kleine Holding GmbH, Bremen (DE)

(72) Inventors: Michael Kleine, Achim (DE); Andreas Kleine, Brermany (DE)

(73) Assignee: Kleine Holding GmbH, Bremen (DE)

(21) Appl. No.: 19/488,538

(22) PCT Filed: May 21, 2024
(86) PCT No.: PCT/EP2024/063938

§ 371 Date: Nov. 26, 2025

(30) Foreign Application Priority Data
May 30, 2023 (DE) 102023114119.8

(51) Int. Cl. B25D 17/08

(52) U.S. Cl. CPC B25D 17/088; B25D 2217/0034; B25D 2217/0042

(57) ABSTRACT

The invention relate to an insertion end (4) of a tool (2) driven rotatably around a longitudinal axis (L) and/or by impact, wherein the insertion end (4) extends along the longitudinal axis (L) proceeding from a holder-side front end (6) of the tool (2) and has a maximum guide diameter (D), with at least two locking grooves (8a, 8b) with a groove width (W) and a longitudinal extension (LN), which run in the direction of the longitudinal axis (L), and are spaced apart relative to each other in the circumferential direction (U), wherein the locking grooves (8a, 8b) are set up to cooperate with at least one locking means of a tool holder (100), and wherein the locking grooves (8a, 8b) are closed in an axial direction (A) at a locking end (10) facing the holder-side front end (6), as well as at least two rotary drive grooves (12a, 12b) that run in the direction of the longitudinal axis (L) and are spaced apart relative to each other in the circumferential direction, which are set up to cooperate with a respective one rotary drive means of the same tool holder (100), wherein the rotary drive grooves (12a, 12b) extend proceeding axially from the holder-side front end (6), and are open toward the front end (6). The invention further relates to a method and a tool holder (100).

The invention relates to an insertion end of a tool driven rotatably around a longitudinal axis and/or by impact, wherein the insertion end extends along the longitudinal axis proceeding from a holder-side front end of the tool and has a maximum guide diameter, with at least two locking grooves with a groove width and a longitudinal extension, which run in the direction of the longitudinal axis and are spaced apart relative to each other in the circumferential direction, wherein the locking grooves are closed in an axial direction at a locking end facing the holder-side front end, as well as two rotary drive grooves running in the direction of the longitudinal axis and spaced apart relative to each other in the circumferential direction, which are set up to cooperate with a respective rotary drive means of the same tool holder, wherein the rotary drive grooves extend axially proceeding from the holder-side front end, and are open toward the front end.

Known from prior art is to guide tools with one insertion end which are driven by impact and rotation in a tool holder in a form-fitting, rotationally stable and limitedly axially movable manner. The insertion end is locked via two locking bodies that penetrate into the locking grooves.

The insertion end and allocated tool holders currently used the most worldwide in hammer drill systems date back to laid-open patent specification DE 2551125. A holder-side, cylinder-shaped guiding surface with a guide diameter of 10 mm is known from the document, wherein axial open rotary drive grooves are provided toward the tool-side front end. In the allocated tool holder, at least one radially adjustable locking body engages into the locking groove, and in this way limits the axial movability of the tool in the tool holder. In addition, two opposing rotary drive bars engage into one rotary drive groove of the insertion end each, and transfer the torque via one tangential contact surface each. It was originally provided that insertion ends like these be provided with smaller drill diameters of up to 17 mm, and that the latter be used in conjunction with drill hammers with a power of up to 650 W. Little if any signs of wear have been observed in practice for such combinations of tools and drive machines.

Recent times have seen the increased development of more powerful drive machines, in particular drill hammers, which permit the transfer of higher torques. As a consequence, larger and larger drill diameters, for example of up to 30 mm, are being realized for existing insertion end systems. However, the resultant disadvantage here is that increasing wear and damage to the tool holder and insertion ends is observed at drill diameters like these. However, the widespread use of drill hammer systems that are compatible with existing insertion ends would argue against the complete redevelopment of tool holders.

In order to avoid such signs of wear, EP 1 537 956 B1 proposes that the rotary drive groove be lengthened in an axial direction proceeding from the holder-side front end, such that the rotary drive groove has a longitudinal extension that clearly exceeds the longitudinal extension of the locking groove. In this approach, however, it turned out that, in order to avoid signs of wear, the rotary drive groove has to be lengthened in such a way that not enough space remains in the area of the insertion end for labeling or stamping the insertion end on the one hand, and on the other that the longitudinal extension of the rotary drive groove led to leakage problems observed in relation to the tool holder, since the rotary drive groove allows dust to bypass seals provided on the machine side.

Against this backdrop, the object of the invention was to further develop an insertion end as well as a tool holder of the kind mentioned at the outset in such a way as to eliminate the disadvantages found in prior art as much as possible. In particular, an insertion end was indicated which is compatible with existing systems while at the same time being less susceptible to damage and wear, in particular at higher drill diameters and higher machine performances.

According to the invention, the object for an insertion end of the kind mentioned at the outset is achieved by the features in the characterizing clause of claim 1.

The invention makes use of the knowledge that the additional rotary drive surfaces are set up to transfer a portion of the torque between the insertion end and tool holder. As a consequence, only a portion of the overall torque has to be transferred via the rotary drive grooves. The risk of wear and damage to the tool holder and the insertion end is thereby reduced, even when using larger drill diameters, e.g., of 30 mm, and more powerful drill hammers. In order to realize the inventive advantages in relation to wear reduction, it is required that the insertion end be used with a tool holder according to the invention. However, the insertion end according to the invention is not limited to this type of use. Rather, it is completely compatible with existing SDS systems. Furthermore, the insertion end is prevented from being incorrectly inserted into a tool holder and resulting in so-called snubbing.

By providing the flanks, a torque can be transferred to an insertion end with little wear. For a given torque, the flanks can be used to indicate an insertion end which has a lower axial extension and yet is low wear. The insertion end thus also has a lower mass, and less material is needed for its manufacture. A correspondingly designed holder can also be given a more compact design, in particular one with less of an axial extension. The fact that the locking groove is arranged inside of the surface of the rotary drive surfaces also indicates an especially compact insertion end.

Because the rotary drive surfaces have a larger longitudinal extension in an axial direction proceeding from the holder-side front end than the respectively allocated locking grooves, a corresponding area of the rotary drive surfaces adjacent to the locking grooves is available for cooperating with a corresponding carrying surface of the tool holder and transferring a corresponding torque. At the same time, the rotary drive grooves can be dimensioned in such a way that a wide enough free surface is present at the insertion end for stamping the insertion end, and the insertion end can be sealed relative to the tool holder by sealants provided on the tool holder.

According to an embodiment, the locking groove extends until into an area adjacent to the holder-side front end, but is axially spaced apart from the latter. The distance between the axial border of the locking groove facing the holder-side front end to the holder-side front end is preferably smaller than the guide diameter of the insertion end.

According to an embodiment, the rotary drive surfaces have a transverse extension transverse to the longitudinal axis, which is essentially identical to or larger than the groove width of the locking grooves. The term “essentially identical” here means that the transverse extension of the rotary drive surfaces is identical to the groove width or has slight deviations from it. Configuring the transverse extension in this way ensures that the surface of the rotary drive surface suitable for torque transfer is large enough.

According to an embodiment, the longitudinal extension of the rotary drive grooves is essentially identical to the longitudinal extension of the rotary drive surfaces. As a result, the torque can be transferred both via the rotary drive grooves and the rotary drive surface, wherein the rotary drive grooves or rotary drive surfaces are simultaneously dimensioned in such a way as to avoid or significantly reduce wear on the insertion end in the area of the rotary drive grooves or rotary drive surfaces, even when using larger drill diameters and machine performances.

According to an embodiment, the rotary drive surfaces are designed as essentially flat surfaces or have flat surface sections. This ensures a compatibility with correspondingly designed rotary drive surfaces of the tool holder. According to an embodiment, the rotary drive surfaces and a circumferential outer groove edge of the locking grooves form a shared edge. As a consequence, the rotary drive surfaces are cut, in a sense, by a circumferential outer groove edge of the locking grooves.

According to an embodiment, the insertion end has a uniform guide diameter over its length. This takes into account the idea of compatibility with existing tool holders. In addition, the uniform guide diameter imparts improved guiding properties to the insertion end in a tool holder.

According to an embodiment, the rotary drive surfaces extend up to the holder-side front end or until bordering the holder-side front end, such that the rotary drive surfaces are open to the holder-side front end. This ensures that rotary drive surfaces of the holder opening can interact with the rotary drive surfaces to transfer a torque after the insertion end has been introduced into the tool holder.

According to an embodiment, the longitudinal extension of the rotary drive surfaces is 1.3 to 1.8 times larger than the longitudinal extension of the locking grooves. In this respect, it is ensured that a sufficiently dimensioned surface of the rotary drive surfaces is available for torque transfer.

According to an embodiment, the longitudinal extension of the rotary drive surfaces and/or the rotary drive grooves measures 3.0 to 3.8 times the guide diameter. This ensures that the surface provided for transferring the torque is large enough, and at the same time ensures that enough space still remains in the area of the insertion end for labeling or stamping the insertion end, while making it possible to still seal the insertion end relative to the tool holder. Lengthening the rotary drive surfaces and/or rotary drive grooves beyond the mentioned area would lead to the space available for labeling the insertion end being too small, and cause problems when sealing the insertion end relative to the tool holder.

According to an embodiment, the corner distance measured as a circumferential chord length between a respective rotary drive surface and a rotary drive groove measures 2.5 mm. This ensures that the torques that arise during operation can be transferred without any significant material wear, while at the same time guaranteeing a good guidance within the tool holder. Furthermore, the impact pulse is reliably applied from the tool holder to the insertion end.

According to an embodiment, the first rotary drive groove is arranged diametrically opposite the second rotary drive groove in the circumferential direction. According to an embodiment, the first locking groove is arranged diametrically opposite the second locking groove in the circumferential direction. According to an embodiment, adjacent rotary drive grooves and locking grooves are each arranged offset by 80° to 100°, in particular 90°, in the circumferential direction.

According to an embodiment, the rotary drive surface allocated to the first locking groove is arranged opposite the rotary drive surface allocated to the second locking groove in the circumferential direction. The rotary drive surfaces preferably run essentially parallel to each other.

According to an embodiment, the rotary drive surfaces run essentially parallel to a groove base of the locking grooves. According to an embodiment, a distance between the two rotary drive surfaces in a radial direction measures between 75% and 90% of the guide diameter. In this way, a sufficient groove depth of the locking grooves remains for securely holding the insertion end in the tool holder on the one hand, and a large enough surface of the rotary drive surfaces for torque transfer is available on the other.

According to an alternative embodiment, at least a first rotary drive surface and a second rotary drive surface are allocated to at least one or in particular both locking grooves. According to an embodiment, the rotary drive surfaces allocated to the first locking groove and the rotary drive surfaces allocated to the second locking groove are symmetrically designed transverse to the longitudinal axis. According to an embodiment, the first rotary drive surface allocated to a locking groove has at least two respective flanks running in the direction of the longitudinal axis. According to an embodiment, the second rotary drive surface also has at least two respective flanks running in the direction of the longitudinal axis. The flanks allocated to a rotary drive surface preferably have an exterior angle of 180° to 230°. In other words, the first rotary drive surface and the second rotary drive surface each preferably have a symmetrical V-shaped design. In this way, torques can be transferred especially efficiently between the insertion end and tool holder, wherein such a design for the insertion end also ensures a compatibility with existing tool holders.

According to an alternative embodiment, the first rotary drive surface and the second rotary drive surface have a V-shaped design, wherein the V-shape is asymmetrically designed, such that the base of the contacting first rotary drive surface and the second rotary drive surface are unilaterally shifted in the circumferential direction. In particular, the rotary drive surface running in the direction of tool rotation, i.e., the loaded one, is steeper. This yields a steeper engagement angle for a correspondingly designed tool holder and corresponding carrying means, as a result of which the torque transfer can be optimized in the direction of rotation of the tool.

According to an embodiment, flanks of the first rotary drive surface and the second rotary drive surface that are adjacent in the circumferential direction have an internal angle of 80° to 120° relative to each other. According to an embodiment, a cylindrical surface section is arranged between the flanks of the first rotary drive surface and second rotary drive surface that are adjacent in the circumferential direction. A diameter of the cylindrical surface section preferably corresponds to the guide diameter. According to an embodiment, the cylindrical surface section extends preferably completely along the longitudinal extension of the rotary drive surfaces, and is interrupted by the respective locking groove, wherein the cylindrical surface section bilaterally axially adjoins the locking groove, and forms elevations that extend radially outward in relation to the locking groove. In this way, the sections of the cylindrical surface section adjoining the locking groove and the rotary drive surfaces provide a backstop for the insertion end in the tool holder. In other words, the cylindrical surface section and the locking surfaces yield an improved axial support for the locking elements engaging into the locking grooves.

The invention was described above with reference to an insertion end. In a further aspect, the invention relates to a method for manufacturing an insertion end according to one of the above claims.

With respect to the method, the invention achieves the object denoted at the outset with the following procedural steps: a) providing a cylindrical semi-finished tool, b) introducing the semi-finished product into a die with a partial reduction in the diameter of the semi-finished product, c) forming the rotary drive grooves, d) forming the rotary drive surfaces, optionally e) introducing the semi-finished product into a locking die and engraving the locking grooves by radially feeding movable forming bodies located in the locking die, wherein the rotary drive grooves and rotary drive surfaces are formed in the same die.

In this way, an especially efficient forming of the rotary drive grooves and rotary drive surfaces is achieved, since the latter are formed in only one die. Die changing processes are thus kept to a minimum. In addition, an alignment or calibration process otherwise required when using two dies is no longer necessary for manufacturing the rotary drive grooves and rotary drive surfaces. The device provided for manufacturing the insertion ends can thus be given a less complex, and thus cost-effective, design as a whole. The method makes use of the same advantages and preferred embodiments as the insertion end according to the invention and vice versa. In this regard, reference is made to the above statements, and the content therein is hereby included.

In an additional aspect, the invention relates to a tool holder with a holder opening for an insertion end, in particular according to one of the above exemplary embodiments. The invention achieves the task designated at the outset in relation to the tool holder via at least one radially adjustable locking element arranged in locking openings for interacting with axially closed locking grooves, at least two carrying bars for interacting with rotary drive grooves axially open toward the holder-side front end of the insertion end, as well as at least one carrying surface for interacting with rotary drive surfaces axially open toward the holder-side front end of the insertion end, wherein the axial projection of the carrying surfaces overlaps the axial projection of the area of the respective locking element that protrudes into the holder opening.

In this way, the insertion end is held securely in the tool holder on the one hand, and a torque transfer by means of carrying bars and carrying surfaces is ensured on the other, so that a higher torque as a whole can be transferred between the tool holder and insertion end, without any fear of excessive wear on the components.

According to an embodiment, the carrying bars are arranged at least approximately diametrically opposite each other in the axial direction. According to an embodiment, the locking elements are arranged diametrically opposite each other. The locking elements are preferably designed like balls or rollers.

According to an embodiment, the longitudinal extension of the carrying surface and the carrying bars is at least approximately identical, and in particular measures 1.5 to 2.0 times the maximum axial play of the insertion end. In this way, a reliable torque transfer is achieved between the insertion end and tool holder.

According to an embodiment, two carrying surfaces are provided, which are configured and arranged essentially diametrically opposite each other and in particular parallel to each other. This enables an advantageous power transmission from the tool holder to a correspondingly designed insertion end.

According to an embodiment, the carrying surfaces have a flat design. According to an embodiment, the center line of the carrying surfaces and the center line of the locking openings align.

According to an alternative embodiment, four carrying surfaces are provided, wherein a respective two of the four carrying surfaces are arranged adjacent to each other in the circumferential direction, and wherein the axial projection of a respective two adjacent carrying surfaces at least partially overlaps the axial projection of an area of the respective locking element that protrudes into the holder opening. The carrying surfaces are preferably symmetrically designed transverse to the longitudinal axis.

According to an embodiment, the adjacent carrying surfaces each have at least two, in particular flat, flanks running in the direction of the longitudinal axis. According to an embodiment, the flanks allocated to a carrying surface have an external angle relative to each other of 180°to 230°. According to an embodiment, adjacent flanks of adjacent carrying surfaces have an internal angle relative to each other of 80° to 120°.

Otherwise, the tool holder makes use of the same advantages and preferred embodiments as the insertion end according to the invention and the method according to the invention and vice versa. In this regard, reference is made to the above statements, and the content therein is hereby included.

In another aspect, the invention relates to the use of a tool holder according to one of the above exemplary embodiments for holding an insertion end according to one of the above exemplary embodiments. The invention makes use of the same advantages and preferred embodiments as the insertion end according to the invention and the tool holder according to the invention and vice versa. In this regard, reference is made to the above statements, and the content therein is hereby included.

The invention will be described in more detail below based on the following exemplary embodiments:
1. Exemplary embodiment: Insertion end (4) of a tool (2) driven rotatably around a longitudinal axis (L) and/or by impact, wherein the insertion end (4) extends along the longitudinal axis (L) proceeding from a holder-side front end (6) of the tool (2) and has a maximum guide diameter (D), with
   at least two locking grooves (8a, 8b) with a groove width (W) and a longitudinal extension (L_{N}), which run in the direction of the longitudinal axis (L) and are spaced apart relative to each other in the circumferential direction (U), wherein the locking grooves (8a, 8b) are set up to cooperate with at least one locking means of a tool holder (100), and wherein the locking grooves (8a, 8b) are closed in an axial direction (A) at a locking end (10) facing the holder-side front end (6),
   as well as at least two rotary drive grooves (12a, 12b) that run in the direction of the longitudinal axis (L) and are spaced apart relative to each other in the circumferential direction, which are set up to cooperate with a respective one rotary drive means of the same tool holder (100), wherein the rotary drive grooves (12a, 12b) extend proceeding axially from the holder-side front end (6) and are open toward the front end (6),
   wherein a rotary drive surface (14a, 14b, 15a, 15b) that overlaps the respective locking groove (8a, 8b) is allocated to at least one locking groove (8a, 8b), and set up to cooperate with a carrying surface of the same tool holder (100),
   wherein the rotary drive surfaces (14a, 14b, 15a, 15b) have a longitudinal extension (L_{F}) in the axial direction (A) proceeding from the holder-side front end that is larger than the longitudinal extension (L_{N}) of the respective locking groove (8a, 8b).
2. Exemplary embodiment: Insertion end (4) according to exemplary embodiment 1, characterized in that the rotary drive surfaces (14a, 14b, 15a, 15b) have a transverse extension (Q) transverse to the longitudinal axis (L), which is essentially identical to or larger than the groove width (W) of the locking grooves (8a, 8b).
3. Exemplary embodiment: Insertion end (4) according to exemplary embodiment 1 or 2, characterized in that the longitudinal extension (L_{D}) of the rotary drive grooves (12a, 12b) is essentially identical to the longitudinal extension (L_{F}) of the rotary drive surfaces (14a, 14b, 15a, 15b).
4. Exemplary embodiment: Insertion end (4) according to one of the preceding exemplary embodiments,
characterized in that the rotary drive surfaces (14a, 14b, 15a, 15b) are designed as essentially flat surfaces (30) or have flat surface sections.
5. Exemplary embodiment: Insertion end (4) according to one of the preceding exemplary embodiments,
characterized in that the rotary drive surfaces (14a, 14b, 15a, 15b) and a circumferential outer groove edge (16) of the locking grooves (8a, 8b) form a shared edge (18).
6. Exemplary embodiment: Insertion end (4) according to one of the preceding exemplary embodiments,
characterized in that the longitudinal extension (L_{F}) of the rotary drive surfaces (14a, 14b, 15a, 15b) is 1.3 times to 1.8 times larger than the longitudinal extension (L_{N}) of the locking grooves (8a, 8b).
7. Exemplary embodiment: Insertion end (4) according to one of the preceding exemplary embodiments,
characterized in that the longitudinal extension (L_{F}) of the rotary drive surfaces (14a, 14b, 15a, 15b) and/or the rotary drive grooves (12a, 12b) measures 3.0 to 3.8 times the guide diameter (D).
8. Exemplary embodiment: Insertion end (4) according to one of the preceding exemplary embodiments,
characterized in that the corner distance (E) between the rotary drive surfaces (14a, 14b) and rotary drive grooves (12a, 12b) measures at least 2.5 mm.
9. Exemplary embodiment: Insertion end (4) according to one of the preceding exemplary embodiments,
characterized in that the rotary drive surface (14a) allocated to the first locking groove (8a) is arranged opposite the rotary drive surface (14b) allocated to the second locking groove (8b) in the circumferential direction (U).
10. Exemplary embodiment: Insertion end (4) according to exemplary embodiment 9, characterized in that the rotary drive surfaces (14a, 14b) run essentially parallel to each other.
11. Exemplary embodiment: Insertion end (4) according to one of the preceding exemplary embodiments, characterized in that a distance between the two rotary drive surfaces (14a, 14b) in a radial direction measures between 75% and 90% of the guide diameter (D).
12. Exemplary embodiment: Insertion end (4) according to one of exemplary embodiments 1 to 8,
characterized in that at least a respective first rotary drive surface (14a, 14b) and second rotary drive surface (15a, 15b) are allocated to the locking grooves (8a, 8b).
13. Exemplary embodiment: Insertion end (4) according to exemplary embodiment 12, characterized in that the rotary drive surfaces (14a, 15a) allocated to the first locking groove (8a) and the rotary drive surfaces (14b, 15b) allocated to the second locking groove (8b) are symmetrically designed transverse to the longitudinal axis (L).
14. Exemplary embodiment: Insertion end (4) according to exemplary embodiment 12 or 13,
characterized in that the first rotary drive surface (14a, 14b) and second rotary drive surface (15a, 15b) allocated to a locking groove (8a, 8b) each have at least two flanks (22) running in the direction of the longitudinal axis, which include an external angle (24) of 190° to 230° relative to each other.
15. Exemplary embodiment: Insertion end (4) according to exemplary embodiment 14, characterized in that flanks of the first rotary drive surface (14a, 14b) and second rotary drive surface (15a, 15b) that are adjacent in the circumferential direction (U) include an internal angle (26) of 80° to 120° relative to each other.
16. Exemplary embodiment: Insertion end (4) according to exemplary embodiment 14 or 15,
characterized in that a cylindrical surface section (28) is arranged between the flanks (22) of the first rotary drive surface (14a, 14b) and the second rotary drive surface (15a, 15b) that are adjacent in the circumferential direction (U), which extends along the longitudinal extension (LF) of the rotary drive surfaces (14a, 14b, 15a, 15b), and is interrupted by the respective locking groove (8a, 8b), wherein the cylindrical surface section (28) bilaterally axially adjoins the locking groove (8a, 8b), and forms elevations (36) that extend radially outward in relation to the locking groove (8a, 8b).
17. Exemplary embodiment: Insertion end (4) according to one of exemplary embodiments 12 to 16,
characterized in that the four rotary drive surfaces (14a, 14b, 15a, 15b) form four flank pairs (22) and a total of eight flanks (22) in the circumferential direction (U).
18. Exemplary embodiment: Method for manufacturing an insertion end (4) according to one of the preceding exemplary embodiments, characterized by the following procedural steps:
a) Providing a cylindrical semi-finished tool,
b) Introducing the semi-finished product into a die with a partial reduction in the diameter of the semi-finished product,
c) Forming the rotary drive grooves (12a, 12b),
d) Forming the rotary drive surfaces (14a, 14b, 15a, 15b), e) Optionally introducing the semi-finished product into a locking die and engraving the locking grooves (8a, 8b) by radially feeding movable forming bodies located in the locking die,
wherein the rotary drive grooves (12a, 12b) and rotary drive surfaces (14a, 14b, 15a, 15b) are formed in the same die.
19. Exemplary embodiment: Tool holder (100) with a holder opening (102) for an insertion end (4), in particular according to one of exemplary embodiments 1 to 17,
   characterized by at least one radially adjustable locking element (106) arranged in locking openings (104) for interacting with axially closed locking grooves (8a, 8b),
   at least two carrying bars (108) for interacting with rotary drive grooves (12a, 12b) axially open toward the holder-side front end (6) of the insertion end (4),
   as well as at least one carrying surface (110) for interacting with rotary drive surfaces (14a, 14b, 15a, 15b) axially open toward the holder-side front end (6) of the insertion end (4),
   wherein the axial projection of the carrying surfaces (110) at least partially overlaps the axial projection of the area of the respective locking element (106) that protrudes into the holder opening (102).
20. Exemplary embodiment: The tool holder (100) according to exemplary embodiment 19, characterized in that the carrying bars (108) are arranged at least approximately diametrically opposite each other in the axial direction (A).
21. Exemplary embodiment: The tool holder (100) according to one of exemplary embodiments 19 or 20, characterized in that the longitudinal extension (ML) of the carrying surfaces (110) and the carrying bars (108) is at least approximately identical, and in particular measures 1.5 to 2.0 times the maximum axial play (112) of the insertion end (4).
22. Exemplary embodiment: The tool holder (100) according to one of exemplary embodiments 19 to 21, characterized in that the locking elements (106) are arranged at least approximately diametrically opposite each other in the axial direction (A).
23. Exemplary embodiment: The tool holder (100) according to one of exemplary embodiments 19 to 22, characterized in that two carrying surfaces (110) are provided, which are arranged essentially diametrically opposite each other and in particular parallel to each other.
24. Exemplary embodiment: The tool holder (100) according to exemplary embodiment 23, characterized in that the carrying surfaces (110) have a flat design.
25. Exemplary embodiment: The tool holder (100) according to exemplary embodiment 23 or 24, characterized in that the center line of the carrying surfaces (110) and the center line of the locking openings (104) align.
26. Exemplary embodiment: The tool holder (100) according to one of exemplary embodiments 19 to 22,
characterized in that four carrying surfaces (110) are provided, wherein a respective two of the four carrying surfaces (110) are arranged adjacent to each other in the circumferential direction (U), and wherein the axial projection of a respective two adjacent carrying surfaces (110) at least partially overlaps the axial projection of an area of the respective locking element (106) that protrudes into the holder opening (102), in particular wherein the carrying surfaces 100) are symmetrically designed transverse to the longitudinal axis (L).
27. Exemplary embodiment: The tool holder (100) according to exemplary embodiment 26,
characterized in that the carrying surfaces (110) each have at least two, in particular flat, flanks running in the direction of the longitudinal axis, wherein adjacent flanks (122) of a carrying surface (110) have an external angle (124) relative to each other of 190° to 230°, in particular wherein adjacent flanks (122) of adjacent carrying surfaces (110) have an internal angle (126) relative to each other of 80° to 120°.
28. Exemplary embodiment: Use of a tool holder (100) according to one of exemplary embodiments 19 to 27 for holding an insertion end (4) according to one of exemplary embodiments 1 to 17.

The invention will be described in more detail below based on preferred exemplary embodiments, drawing reference to the attached figures.

Shown here on:

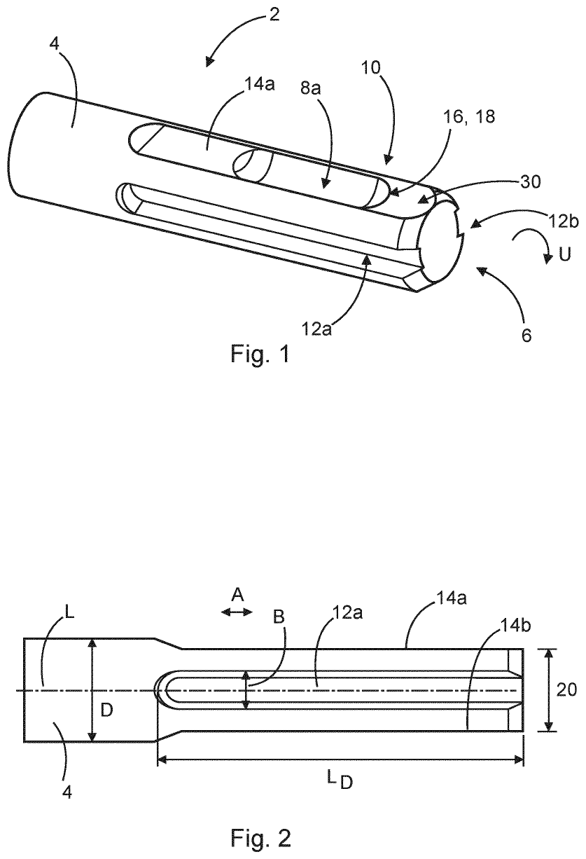

FIG. 1 is a perspective view of a first exemplary embodiment of an insertion end according to the invention;

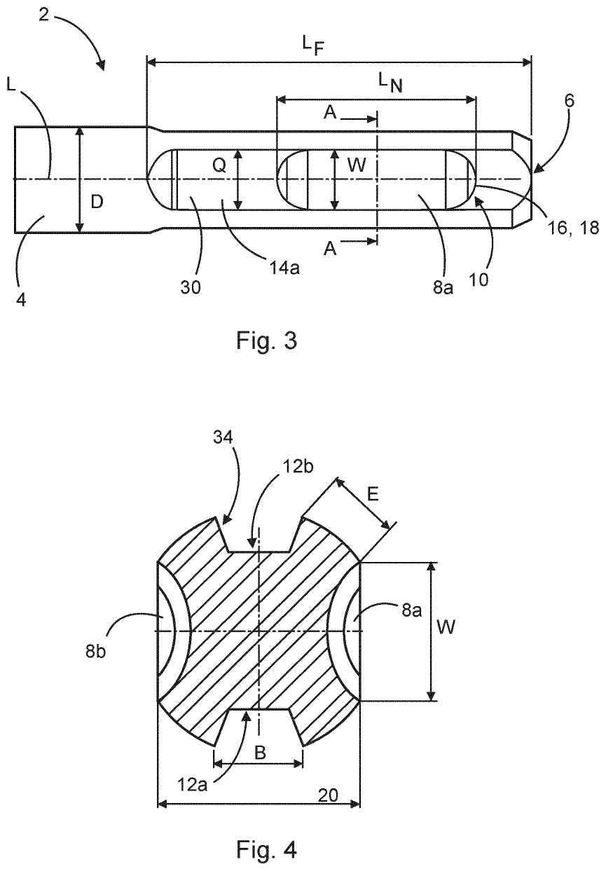

FIGS. 2 and 3 are side views of the exemplary embodiment according to FIG. 1;

FIG. 4 is a sectional view of the exemplary embodiment according to FIG. 1-3;

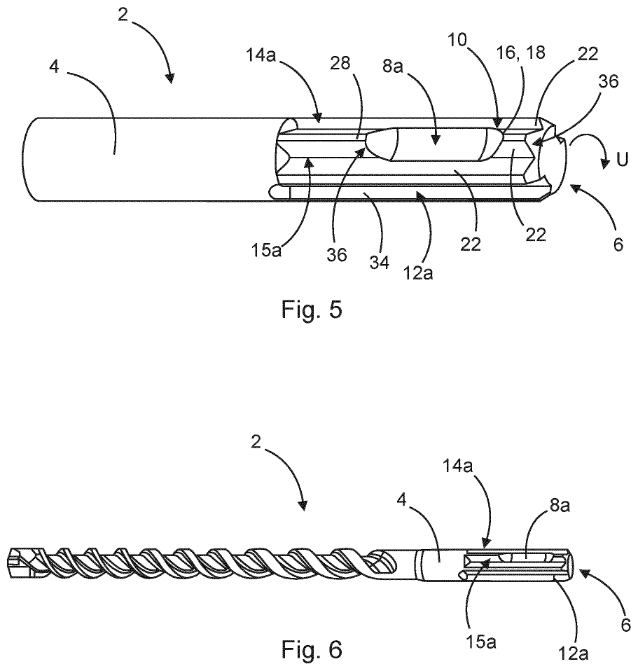

FIGS. 5 and 6 are perspective views of alterative exemplary embodiment of a drill with an insertion end according to the invention;

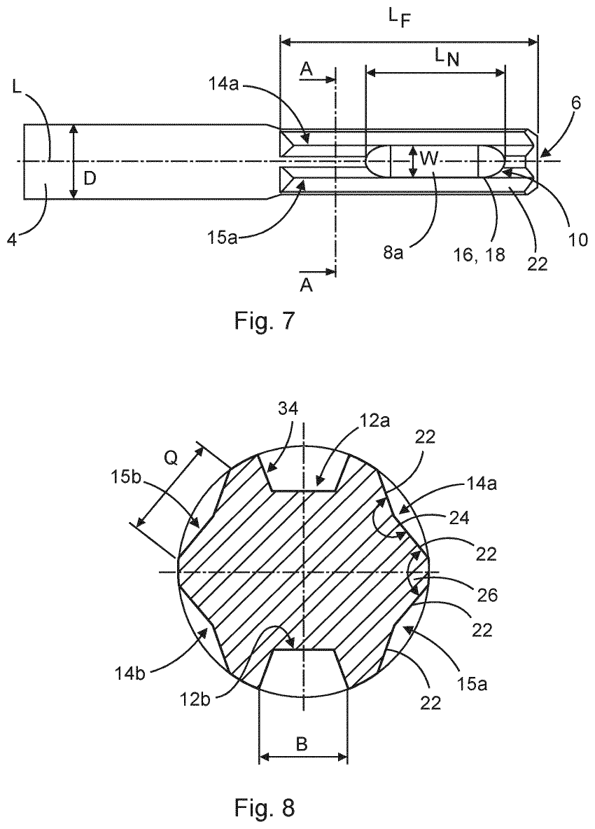

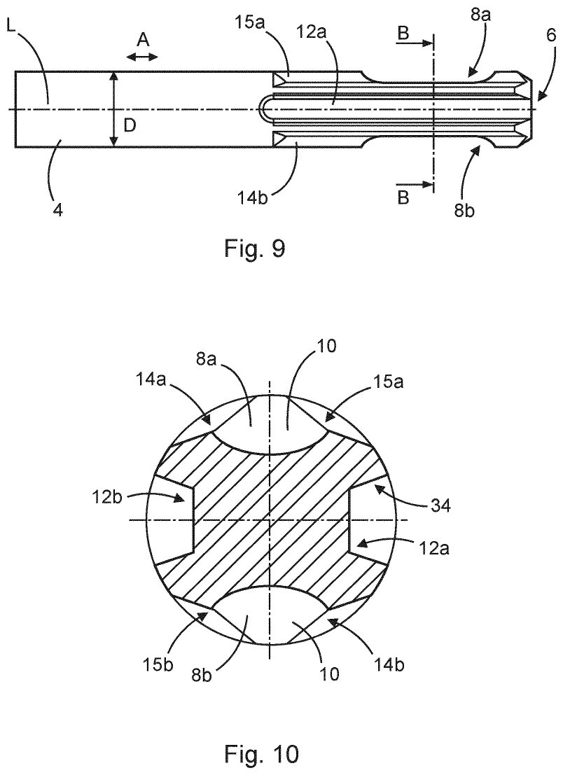

FIG. 7 to 10 are various side views or sectional views of the insertion end according to FIGS. 5 and 6;

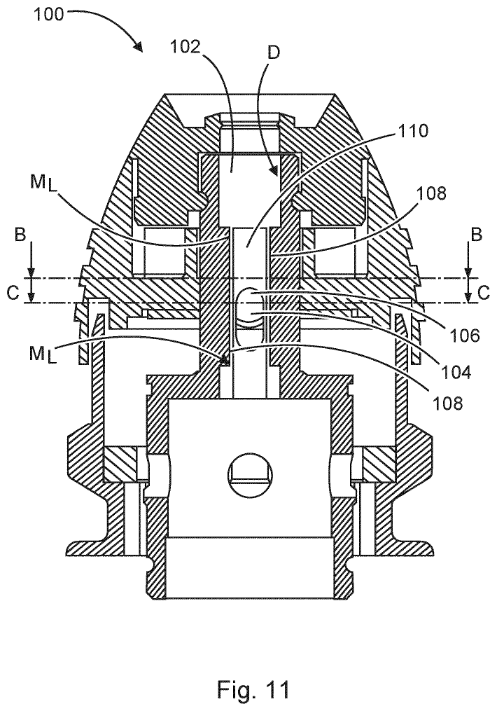

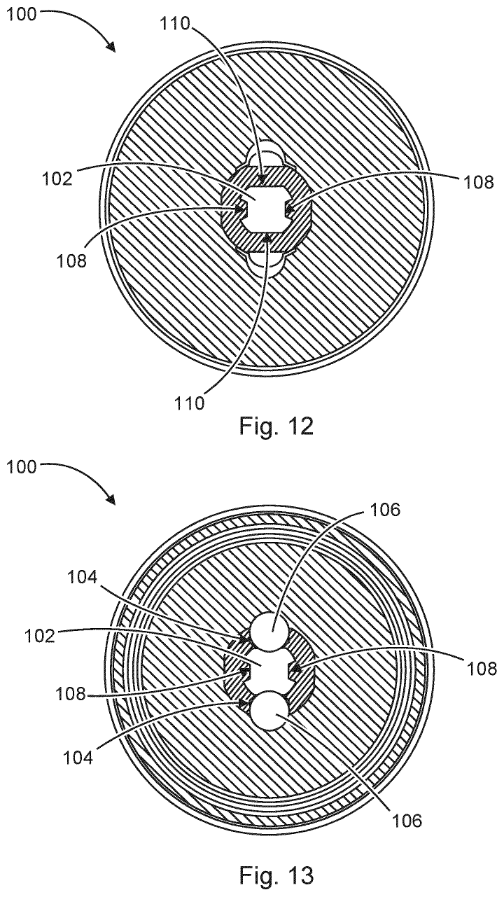

FIG. 11 is a sectional view of a tool holder according to the invention;

FIGS. 12 and 13 are axial sectional views of the tool holder according to the invention on FIG. 11;

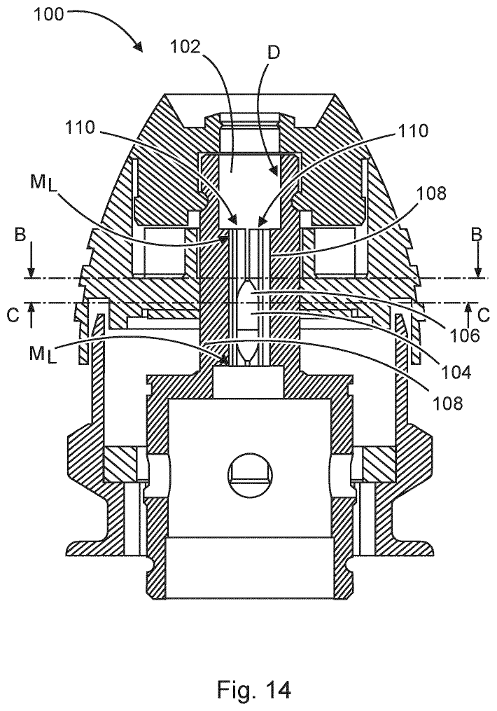

FIG. 14 is a sectional view of an alternative exemplary embodiment of a tool holder according to the invention; and

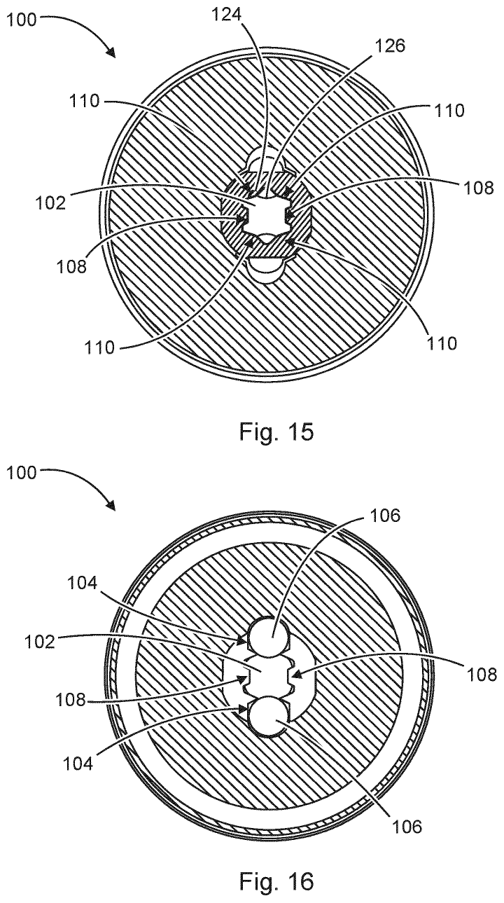

FIGS. 15 and 16 are axial sectional views of the tool holder according to the invention on FIG. 14.

FIGS. 1 to 4 show an insertion end 4 of a tool 2 driven rotatably around a longitudinal axis L and/or by impact. The insertion end 4 extends along the longitudinal axis L proceeding from a holder-side front end 6 of the tool 2. The insertion end 4 has a maximum guide diameter D. The insertion end 4 further has two locking grooves 8a, 8b, which run in the direction of the longitudinal axis L and are spaced apart relative to each other in the circumferential direction U. The locking grooves 8a, 8b each have a groove width W and a longitudinal extension L_{N}. The locking grooves 8a, 8b are set up to cooperate with a respective rotary drive means of a tool holder 100 (see FIGS. 11 to 13). The locking grooves 8a, 8b are closed in an axial direction A at a locking end 10 facing the holder-side front end 6. The insertion end 4 further has two rotary drive grooves 12a, 12b running in the direction of the longitudinal axis L and spaced apart relative to each other in the circumferential direction. The rotary drive grooves 12a 12b are set up to cooperate with a respective rotary drive means of the same tool holder 100. The rotary drive grooves 12a, 12b extend axially proceeding from the holder-side front end 6, and are open toward the front end 6. The rotary drive grooves 12a, 12b each have at least one tangential force surface 34.

The insertion end 4 further has rotary drive surfaces 14a, 14b, which are allocated to the locking grooves 8a, 8b. The rotary drive surfaces 14a, 14b are set up to cooperate with a carrying surface of the same tool holder 100. The rotary drive surfaces 14a, 14b have a longitudinal extension L_{F} in the axial direction A proceeding from the holder-side front end 6 which is larger than the longitudinal extension LN of the respective locking groove 8a, 8b. The rotary drive surface 14a allocated to the first locking groove 8a is arranged opposite the rotary drive surface 14b allocated to the second locking groove 8b in the circumferential direction U, as visible in particular on FIG. 2. The rotary drive surfaces 14a, 14b run essentially parallel to each other. A distance 20 between the two rotary drive surfaces 14a, 14 b in a radial direction measures between 75% and 90% of the guide diameter D of the insertion end 4.

The rotary drive surfaces 14a,14b have a transverse extension Q transverse to the longitudinal axis L. The transverse extension Q is essentially equal to or larger than the groove width W of the locking grooves 8a, 8b. The longitudinal extension L_{D} of the rotary drive grooves 12a, 12b is essentially identical to the longitudinal extension L_{F} of the rotary drive surfaces 14a, 14b. In the exemplary embodiment shown on FIGS. 1 to 4, the rotary drive surfaces 14a, 14b are designed as essentially flat surfaces 30. The rotary drive surfaces 14a, 14b and a circumferential outer groove edge 16 of the respective locking grooves 8a, 8b form a shared edge 18. The rotary drive surfaces 14a, 14b extend up to the holder-side front end 6, such that the rotary drive surfaces 1a, 1b are open toward the holder-side front end 6.

The longitudinal extension L_{F} of the rotary drive surfaces 14a, 14b is 1.3 to 1.8 times larger than the longitudinal extension L_{N} of the locking grooves 8a, 8b. Furthermore, the longitudinal extension L_{F} of the rotary drive surfaces 14a, 14b and the rotary drive grooves 12a, 12b is 3.0 to 3.8 times the guide diameter. As shown on FIG. 4, the corner distance E between the rotary drive surfaces 14a, 14b and the rotary drive grooves 12a, 12b measures at least 2.5 mm. The first rotary drive groove 12a and the second rotary drive groove 12b are arranged diametrically opposite each other in the circumferential direction U. The first locking groove 8a and the second locking groove 8b are likewise arranged diametrically opposite each other in the circumferential direction U. In the embodiment shown on FIGS. 1 to 4, the rotary drive grooves 12a, 12b and the locking grooves 8a, 8b are arranged offset in the circumferential direction U by a respective 90°.

FIGS. 5 to 10 show an additional exemplary embodiment of an insertion end 4 according to the invention of a tool 2 driven rotatably around a longitudinal axis L and/or by impact, which as shown on FIG. 6 can be designed like a drill, for example. The insertion end 4 extends along the longitudinal axis L proceeding from a holder-side front end 6 of the tool 2, and as already described with reference to FIGS. 1 to 4, has a maximum guide diameter D. The exemplary embodiment shown on FIGS. 5 to 10 also has two locking grooves 8a, 8b running in the direction of the longitudinal axis L and spaced apart from each other in a circumferential direction U, which have a groove width W and a longitudinal extension LN. The locking grooves 8a, 8b are closed in an axial direction A at the locking end 10 facing the holder-side front end 6. Additionally provided are two rotary drive grooves 12a, 12b that run in the direction of the longitudinal axis L and are spaced apart from each other in a circumferential direction. The latter extend axially proceeding from the holder-side front end 6, and are open toward the front end 6. The rotary drive grooves 12a, 12b each have at least one tangential force surface 34. In the second exemplary embodiment, each of the locking grooves 8a, 8b have allocated to them two rotary drive surface 14a, 14b, 15a, 15b overlapping the respective locking groove 8a, 8b.

The rotary drive surfaces 14a, 14b, 15a, 15b have a longitudinal extension L_{F} in an axial direction A proceeding from the holder-side front end 6 that is larger than the longitudinal extension L_{N} of the respective locking groove 8a, 8b. A respective first rotary drive surface 14a, 14b and a second rotary drive surface 15a, 15b are allocated to the locking grooves 8a, 8b. The rotary drive surfaces 14a, 15a allocated to the first locking groove 8a and the rotary drive surfaces 14b, 15b allocated to the second locking groove 8b are symmetrically designed transverse to the longitudinal axis L. The first rotary drive surface 14a, 14b allocated to a locking groove 8a, 8b and the second rotary drive surface 15a, 15b each have two flanks 22 running in the direction of the longitudinal axis, which are aligned like a V relative to each other.

The flanks 22 have an external angle 24 relative to each other. In addition, flanks of the first rotary drive surface 14a, 14b and the second rotary drive surface 15a, 15b adjacent in the circumferential direction U have an internal angle 26 relative to each other. In the area not interrupted by the locking grooves 8a, 8b, a cylindrical surface section 28 is arranged between the flanks 22 of the first rotary drive surface 14a, 14b and the second rotary drive surface 15a, 15b adjacent in the circumferential direction U. In particular, the cylindrical surface section 28 extends completely along the longitudinal extension LF of the rotary drive surfaces 14a, 14b, 15a, 15b. The cylindrical surface section 28 bilaterally axially adjoins the locking groove 8a, 8b, and forms elevations 36 that extend radially outward in relation to the locking groove 8a, 8b. The elevation 36 allows the insertion end 4 to have a high degree of withdrawal safety, since a locking body engaging into the locking grooves 8a, 8b is axially held by the elevation 36. The cylindrical surface section 28 in conjunction with the rotary drive surfaces 14a, 14b, 15a, 15b provides an improved axial mounting of a locking body introduced into the locking grooves 8a, 8b. The four rotary drive surfaces 14a, 14b, 15a, 15b form four flank pairs 22 and a total of eight flanks 22 in the circumferential direction U.

The rotary drive surfaces 14a, 14b, 15a, 15b have a transverse extension Q transverse to the longitudinal axis L, which is essentially identical to or larger than the groove width W of the locking grooves 8a, 8b. Furthermore, the longitudinal extension L_{D} of the rotary drive grooves 12a, 12b is essentially identical to the longitudinal extension L_{F} of the rotary drive surfaces 14a, 14b, 15a, 15b in the exemplary embodiment shown on FIGS. 5 to 10. The rotary drive surfaces 14a, 14b, 15a, 15b have flat sections in the form of the flanks 22, which can correspond with a correspondingly designed tool holder. The rotary drive surfaces 14a, 14b, 15a, 15b and a circumferential outer groove edge 16 of the locking grooves 8a, 8b form a shared edge 18. Furthermore, the rotary drive surfaces 14a, 14b, 15a, 15b extend up to the holder-side front end 6, such that the rotary drive surfaces 14a, 14b, 15a, 15b are open toward the holder-side front end 6. The first rotary drive groove 12a is arranged diametrically opposite the second rotary drive groove 12b in the circumferential direction U. The first locking groove 8a is arranged diametrically opposite the second locking groove 8b in the circumferential direction U. Adjacent rotary drive grooves 12a, 12b and locking grooves 8a, 8 b are spaced apart from each other by about 90° in the circumferential direction.

FIGS. 11 to 13 show a tool holder 100. The tool holder 100 has a holder opening 102 for an insertion end 4. The tool holder 100 has two radially adjustable locking elements 106 arranged in locking openings 104 for interacting with the axially closed locking grooves 8a, 8b. In addition, the tool holder 100 has at least two carrying bars 108 for interacting with the rotary drive grooves 12a, 12b axially open toward the holder-side front end 6 of the insertion end 4. Furthermore, the tool holder 100 has two carrying surfaces 110 for interacting with the rotary drive surfaces 14a, 14b axially open toward the holder-side front end 6 of the insertion end 4. The axial projection of the carrying surfaces 110 overlaps the axial projection of the area of the respective locking element 106 protruding into the holder opening 102.

The carrying bars 108 lie diametrically opposite each other in the axial direction A. The locking elements 106 likewise lie diametrically opposite each other in the axial direction A. The locking elements 106 can be designed as balls, as shown on FIG. 13, or alternatively as rollers. The carrying surfaces 110 are flat in design. The center line of the carrying surfaces 110 and the center line of the locking opening 104 align. In addition, the longitudinal extension M_{L} of the carrying surfaces 110 and the carrying bars 108 are at least approximately identical. In addition, the longitudinal extension M_{L} measures in particular 1.5 to 2.0 times the maximum axial play 112 of the insertion end 4.

FIGS. 14 to 16 show a tool holder 100 for holding an insertion end 4 on FIGS. 5 to 10. The tool holder 100 has a holder opening 102 for an insertion end 4. The tool holder 100 further has two radially adjustable locking elements 106 arranged in locking openings 104 for interacting with the axially closed locking grooves 8a, 8b. In addition, the tool holder 100 has at least two carrying bars 108 for interacting with the rotary drive grooves 12a, 12b axially open toward the holder-side front end 6 of the insertion end 4. Furthermore, the tool holder 100 has four carrying surfaces 110. The carrying surfaces 110 correspond with the rotary drive surfaces 14a, 14b, 15a, 15b.

A respective two of the four carrying surfaces 110 are arranged adjacent to each other in the circumferential direction U. The axial projection of a respective two adjacent carrying surfaces 110 at least partially overlaps the axial projection of an area of the respective locking element 106 that projects into the holder opening 102. The carrying surfaces 110 are symmetrically designed transverse to the longitudinal axis L. The carrying surfaces 110 each have two flat flanks 122 running in the direction of the longitudinal axis. Adjacent flanks 122 of a carrying surface 110 include an external angle 124 of 180° to 230° relative to each other. Adjacent flanks 122 of adjacent carrying surfaces 110 include an internal angle 126 of 80° to 120° relative to each other. The carrying bars 108 lie at least approximately diametrically opposite each other in an axial direction A. The longitudinal extension M_{L} of the carrying surfaces 110 and the carrying bars 108 is at least approximately identical, and in particular measures 1.5 to 2.0 times the maximum axial play 112 of the insertion end 4. The locking elements 106 lie at least approximately diametrically opposite each other in an axial direction A.

[symbol]

### REFERENCE LIST

2 Tool
4 Insertion end
6 Holder-side front end
8a, b Locking grooves
10 Locking end
12a, b Rotary drive grooves
14a, b First rotary drive surfaces
15a, b Second rotary drive surfaces
16 Circumferential outer groove edge
18 Shared edge
20 Distance between the two rotary drive surfaces in the radial direction
22 Flanks of the rotary drive surface
24 External angle of the flanks
26 Internal angle between adjacent flanks
28 Cylindrical surface section
30 Flat surface
32 Flat surface section
34 Tangential force surface
36 Elevations
100 Tool holder
102 Holder opening
104 Locking openings
106 Locking element
108 Carrying bars
110 Carrying surfaces
112 Maximum axial play of the insertion end
122 Flanks
124 External angle
126 Internal angle
A Axial direction
B Width of the rotary drive grooves
D Guide diameter
E Corner distance
L Longitudinal axis
L_{D} Longitudinal extension of the rotary drive grooves
L_{F} Longitudinal extension of the rotary drive surfaces
L_{N} Longitudinal extension of the locking groove
M_{L} Longitudinal extension of the carrying surfaces
Q Transverse extension of the rotary drive surfaces
U Circumferential direction
W Width of the locking grooves

1. An insertion end of a tool configured to be driven rotatably around a longitudinal axis (L) and/or by impact, wherein the insertion end extends along the longitudinal axis (L) proceeding from a holder-side front end of the tool and has a maximum guide diameter (D), with
at least two locking grooves with a groove width (W) and a longitudinal extension (L_{N}), which run in the direction of the longitudinal axis (L) and are spaced apart relative to each other in the circumferential direction (U), wherein the locking grooves are set up to cooperate with at least one locking means of a tool holder, and wherein the locking grooves are closed in an axial direction (A) at a locking end facing the holder-side front end,
as well as at least two rotary drive grooves that run in the direction of the longitudinal axis (L) and are spaced apart relative to each other in the circumferential direction, which are set up to cooperate with a respective one rotary drive means of the same tool holder, wherein the rotary drive grooves extend proceeding axially from the holder-side front end, and are open toward the front end,
wherein a rotary drive surface that overlaps the respective locking groove is allocated to at least one locking groove, and set up to cooperate with a carrying surface of the same tool holder,
wherein the rotary drive surfaces have a longitudinal extension (LF) in the axial direction (A) proceeding from the holder-side front end that is larger than the longitudinal extension (L_{N}) of the respective locking groove,
wherein at least one first rotary drive surface and one second rotary drive surface is allocated to the respective locking grooves, and
characterized in that the four rotary drive surfaces form four flank pairs and a total of eight flanks in the circumferential direction (U).

2. The insertion end according to claim 1, characterized in that the rotary drive surfaces have a transverse extension (Q) transverse to the longitudinal axis (L), which is essentially identical to or larger than the groove width (W) of the locking grooves.

3. The insertion end according to claim 1,
characterized in that the longitudinal extension (L_{D}) of the rotary drive grooves is essentially identical to the longitudinal extension (L_{F}) of the rotary drive surfaces.

4. The insertion end according to claim 1,
characterized in that the rotary drive surfaces have flat surface sections.

5. The insertion end according to claim 1,
characterized in that the rotary drive surfaces and a circumferential outer groove edge of the locking grooves form a shared edge.

6. The insertion end according to claim 1,
characterized in that the longitudinal extension (L_{F}) of the rotary drive surfaces is 1.3 times to 1.8 times larger than the longitudinal extension (L_{N}) of the locking grooves.

7. The insertion end according to claim 1,
characterized in that the longitudinal extension (L_{F}) of at least one of the rotary drive surfaces and the rotary drive grooves measures 3.0 to 3.8 times the guide diameter (D).

8. The insertion end according to claim 1,
characterized in that the corner distance (E) between the rotary drive surfaces and rotary drive grooves measures at least 2.5 mm.

9. The insertion end according to claim 1,
characterized in that the rotary drive surfaces allocated to the first locking groove and the rotary drive surfaces allocated to the second locking groove are symmetrically designed transverse to the longitudinal axis (L).

10. The insertion end according to claim 1,
characterized in that flanks of the first rotary drive surface and second rotary drive surface that are adjacent in the circumferential direction (U) include an internal angle of 80° to 120° relative to each other.

11. The insertion end according to claim 1,
characterized in that a cylindrical surface section is arranged between the flanks of the first rotary drive surface and the second rotary drive surface that are adjacent in the circumferential direction (U), which extends along the longitudinal extension (L_{F}) of the rotary drive surfaces, and is interrupted by the respective locking groove, wherein the cylindrical surface section bilaterally axially adjoins the locking groove, and forms elevations that extend radially outward in relation to the locking groove.

12. (canceled)

13. A method for manufacturing an insertion end according to claim 1, characterized by the following procedural steps:
a) Providing a cylindrical semi-finished tool;
b) Introducing the semi-finished tool into a die with a partial reduction in the diameter of the semi-finished product;
c) Forming the rotary drive grooves; and
d) Forming the rotary drive surfaces.

14. A tool holder with a holder opening for an insertion end according to claim 1,
characterized by at least one radially adjustable locking element arranged in locking openings for interacting with axially closed locking grooves,
at least two carrying bars for interacting with rotary drive grooves axially open toward the holder-side front end of the insertion end,
as well as at least one carrying surface for interacting with rotary drive surfaces axially open toward the holder-side front end of the insertion end,
wherein an axial projection of the carrying surfaces at least partially overlaps an axial projection of the area of the respective locking element that protrudes into the holder opening, four carrying surfaces are provided, wherein a respective two of the four carrying surfaces are arranged adjacent to each other in the circumferential direction (U), and wherein the axial projection of a respective two adjacent carrying surfaces at least partially overlaps the axial projection of an area of the respective locking element that protrudes into the holder opening, wherein the carrying surfaces are symmetrically designed to be transverse to the longitudinal axis.

15. The tool holder according to claim 14, characterized in that the carrying bars lie at least approximately diametrically opposite each other in an axial direction (A).

16. The tool holder according to claim 14, characterized in that a longitudinal extension (M_{L}) of the carrying surfaces and the carrying bars is at least approximately identical, and measures 1.5 to 2.0 times a maximum axial play of the insertion end.

17. The tool holder according to claim 14, characterized in that the locking elements lie at least approximately diametrically opposite each other in an axial direction (A).

18. The tool holder according to claim 14, characterized in that adjacent flanks of adjacent carrying surfaces include an internal angle of 80° to 120° relative to each other.

19. (canceled)

20. The method of claim 13, further comprising introducing the semi-finished product into a locking die and engraving the locking grooves by radially feeding movable forming bodies located in the locking die,
wherein the rotary drive grooves and rotary drive surfaces are formed in the same die.

21. A method of using a tool holder and an insertion end of a tool configured to be driven rotatably around a longitudinal axis (L) and/or by impact, the insertion end extending along the longitudinal axis (L) proceeding from a holder-side front end of the tool and has a maximum guide diameter (D),
the insertion end including:
at least two locking grooves with a groove width (W) and a longitudinal extension (LN), which run in the direction of the longitudinal axis (L) and are spaced apart relative to each other in the circumferential direction (U), wherein the locking grooves are set up to cooperate with at least one locking means of a tool holder, and wherein the locking grooves are closed in an axial direction (A) at a locking end facing the holder-side front end,
at least two rotary drive grooves that run in the direction of the longitudinal axis (L) and are spaced apart relative to each other in the circumferential direction, which are set up to cooperate with a respective one rotary drive means of the same tool holder, wherein the rotary drive grooves extend proceeding axially from the holder-side front end, and are open toward the front end,
wherein a rotary drive surface that overlaps the respective locking groove is allocated to at least one locking groove, and set up to cooperate with a carrying surface of the same tool holder,
wherein the rotary drive surfaces have a longitudinal extension (LF) in the axial direction (A) proceeding from the holder-side front end that is larger than the longitudinal extension (LN) of the respective locking groove,
wherein at least one first rotary drive surface and one second rotary drive surface is allocated to the respective locking grooves, and
characterized in that the four rotary drive surfaces form four flank pairs and a total of eight flanks in the circumferential direction (U)
the tool holder including:
a holder opening for receiving an insertion end of the tool,
at least one radially adjustable locking element arranged in locking openings for interacting with axially closed locking grooves,
at least two carrying bars for interacting with rotary drive grooves axially open toward the holder-side front end of the insertion end,
at least one carrying surface for interacting with rotary drive surfaces axially open toward the holder-side front end of the insertion end,
wherein an axial projection of the carrying surfaces at least partially overlaps an axial projection of the area of the respective locking element that protrudes into the holder opening,
four carrying surfaces are provided, wherein a respective two of the four carrying surfaces are arranged adjacent to each other in the circumferential direction (U), and wherein the axial projection of a respective two adjacent carrying surfaces at least partially overlaps the axial projection of an area of the respective locking element that protrudes into the holder opening, in particular wherein the carrying surfaces are symmetrically designed to be transverse to the longitudinal axis (L);
the method comprising:
inserting the insertion end of the tool into the holder opening of the tool holder;
engaging the at least one radially adjustable locking element of the tool holder with the locking grooves;
engaging the at least two carrying bars with the rotary drive grooves; and
engaging the at least one carrying surface with the rotary drive surfaces.
